(19) United States
(12) Patent Application Publication
(10) Pub. No.: US 2017/0182504 A1
(43) Pub. Date: Jun. 29, 2017

(54) Shower head

(71) Applicant: Chin-Hua Ho, Changhua (TW)

(72) Inventor: Chin-Hua Ho, Changhua (TW)

(21) Appl. No.: 15/456,593

(22) Filed: Mar. 13, 2017

(51) Int. Cl. B05B 1/16; B05B 12/00; B05B 1/18

(52) U.S. Cl. CPC B05B 1/1663; B05B 1/185; B05B 12/002

(57) ABSTRACT

A shower head includes a spray handle; a conduit in the spray handle and including an inlet having a first port, a first outlet having a second port, and a second outlet having a third port; a nozzle assembly including central nozzles and peripheral nozzles; a central channel in the spray handle and communicating with both the first outlet and the central nozzles; a peripheral channel around the central channel and communicating with both the second outlet and the peripheral nozzles; a sliding valve between the inlet and the first and second outlets, the sliding valve including three spaced disc members and two annular cavities each between two adjacent disc members; and two opposite push buttons secured to two ends of the sliding valve respectively. Water flowing out of the central or peripheral nozzles can be controlled by pressing one or the other press button.

### BACKGROUND OF THE INVENTION

1. Field of the Invention

The invention relates to shower heads and more particularly to a shower head capable of flowing water out of central nozzles by pressing a left press button or peripheral nozzles by pressing a right press button.

2. Description of Related Art

Conventional shower heads having a device for controlling water flow direction are well known. However, the switching mechanism of the device is complicated and not convenient in use.

Thus, the need for improvement still exists.

### SUMMARY OF THE INVENTION

It is therefore one object of the invention to provide a shower head comprising a spray handle; a conduit disposed in the spray handle and including an inlet having a first port, a first outlet having a second port, and a second outlet having a third port; a nozzle assembly including a plurality of central nozzles and a plurality of peripheral nozzles; a central channel disposed in the spray handle and communicating with both the first outlet and the central nozzles respectively; a peripheral channel disposed around the central channel and communicating with both the second outlet and the peripheral nozzles respectively; a sliding valve disposed between the inlet and the first and second outlets, the sliding valve including three spaced disc members and two annular cavities each between two adjacent disc members; and two opposite push buttons secured to two ends of the sliding valve respectively; wherein in an inoperative position the first port neither communicates with the second port nor communicates with the third port; wherein a pressing of one press button unblocks the first port to flow water from the inlet to the central nozzles via the first port, the second port, and the first outlet; and wherein a pressing of the other press button unblocks the first port to flow water from the inlet to the peripheral nozzles via the first port, the third port, and the second outlet.

The above and other objects, features and advantages of the invention will become apparent from the following detailed description taken with the accompanying drawings.

### BRIEF DESCRIPTION OF THE DRAWINGS

FIG. 1 is an exploded perspective view of a shower head according to a first preferred embodiment of the invention;

FIG. 2 is a longitudinal sectional view of the shower head;

FIG. 3 is another longitudinal sectional view of the shower head;

FIG. 4 is a view similar to FIG. 2 showing a first water flow path by pressing the left push button;

FIG. 5 is a view similar to FIG. 3 showing the first water flow path;

FIG. 6 is a view similar to FIG. 2 showing a second water flow path by pressing the right push button;

FIG. 7 is a view similar to FIG. 3 showing the second water flow path;

FIG. 8 is a perspective view of a shower head according to a second preferred embodiment of the invention;

FIG. 9 is a longitudinal sectional view of the shower head of FIG. 8 showing a water flow path; and

FIG. 10 is another longitudinal sectional view of the shower head of FIG. 8 showing another water flow path.

### DETAILED DESCRIPTION OF THE INVENTION

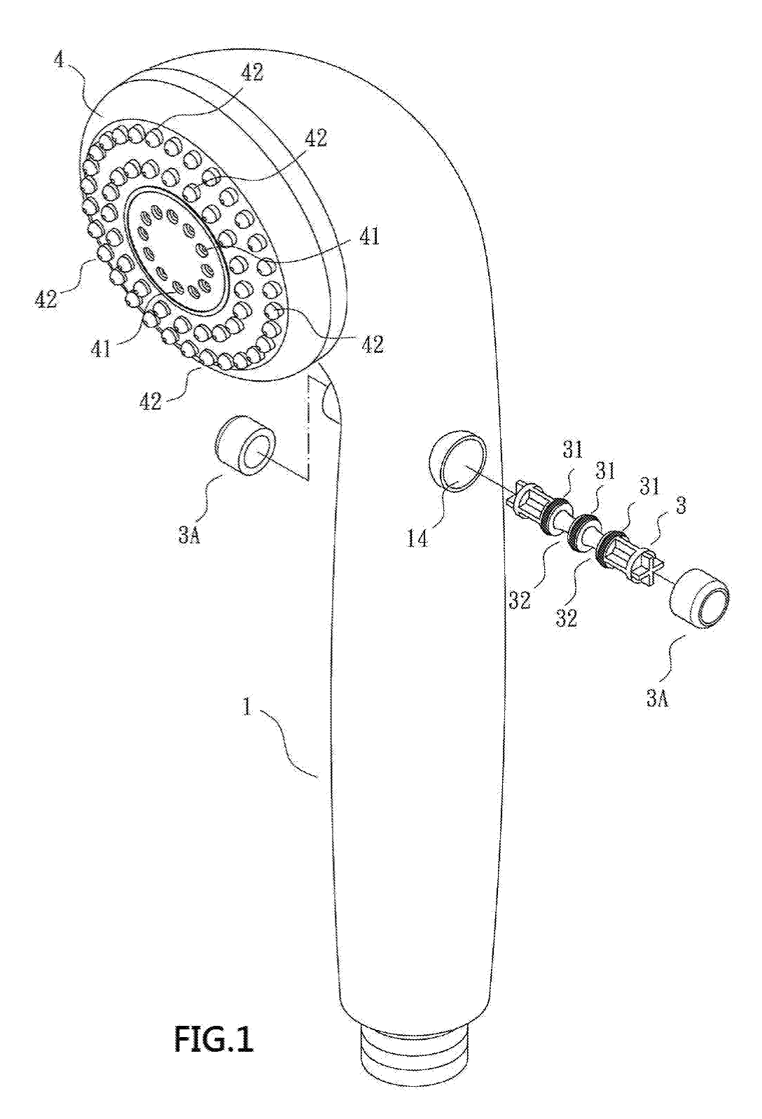

Referring to FIGS. 1 to 7, a shower head in accordance with a first preferred embodiment of the invention comprises the following components as discussed in detail below.

A conduit 2 is provided in a space 11 of a spray handle 1. An annular nozzle assembly 4 is threadedly secured to an externally threaded opening of the spray handle 1. A central channel 12 in the space 11 communicates with the nozzle assembly 4. A peripheral channel 13 is provided around the central channel 12. The peripheral channel 13 and the central channel 12 are spaced apart. Further, the peripheral channel 13 communicates with the nozzle assembly 4. Two aligned bossed holes 14 are provided on the spray handle 1 and communicate with each other. A press button 3A is partially provided in each bossed hole 14. The conduit 2 includes an inlet 21 and two outlets 22. A latch 221 is provided at an end of each outlet 22 and secured to the central channel 12, thereby fastening the conduit 2. One outlet 22 communicates with the central channel 12 and the other outlet 22 communicates with the peripheral channel 13 respectively. The nozzle assembly 4 includes a plurality of central nozzles 41 and a plurality of peripheral nozzles 42 around the central nozzles 41. A sliding valve 3 is provided at a portion joining the inlet 21 and the outlets 22 and has two ends fastened in the press buttons 3A respectively. The sliding valve 3 includes three spaced disc members 31, and an annular cavity 32 between any two adjacent disc members 31.

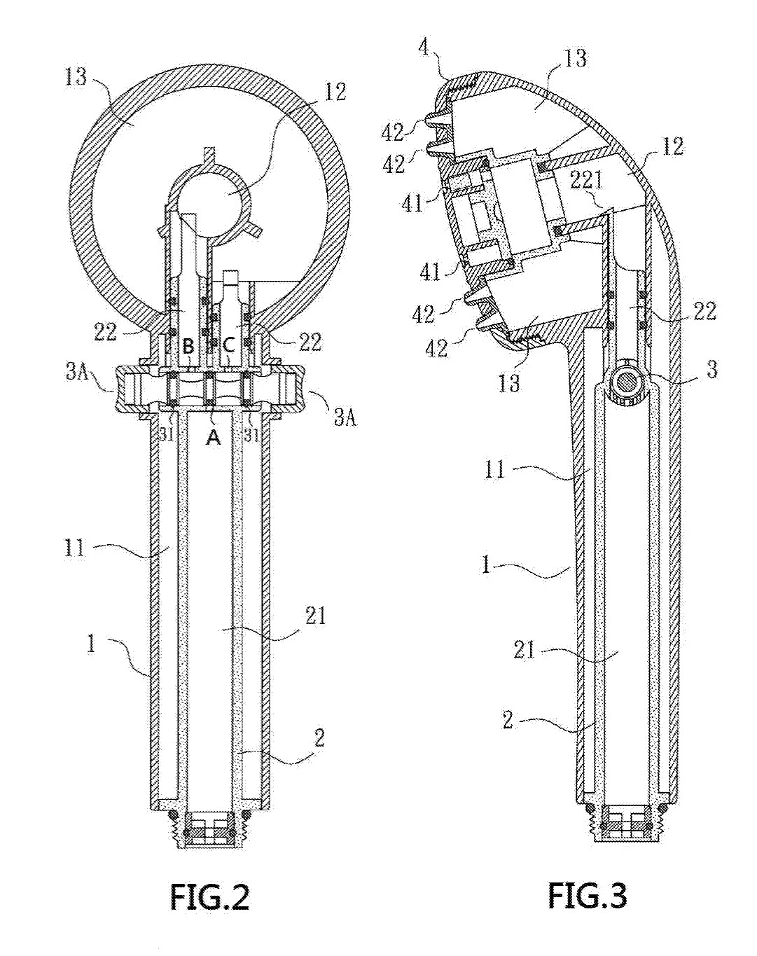

As shown in FIGS. 2 and 3, in an inoperative position with both the press buttons 3A disposed in a default position, a first port A at an end of the inlet 21 neither communicates with a second port B at an end of one outlet 22 nor communicates with a third port C at an end of the other outlet 22. In short, there is no water output.

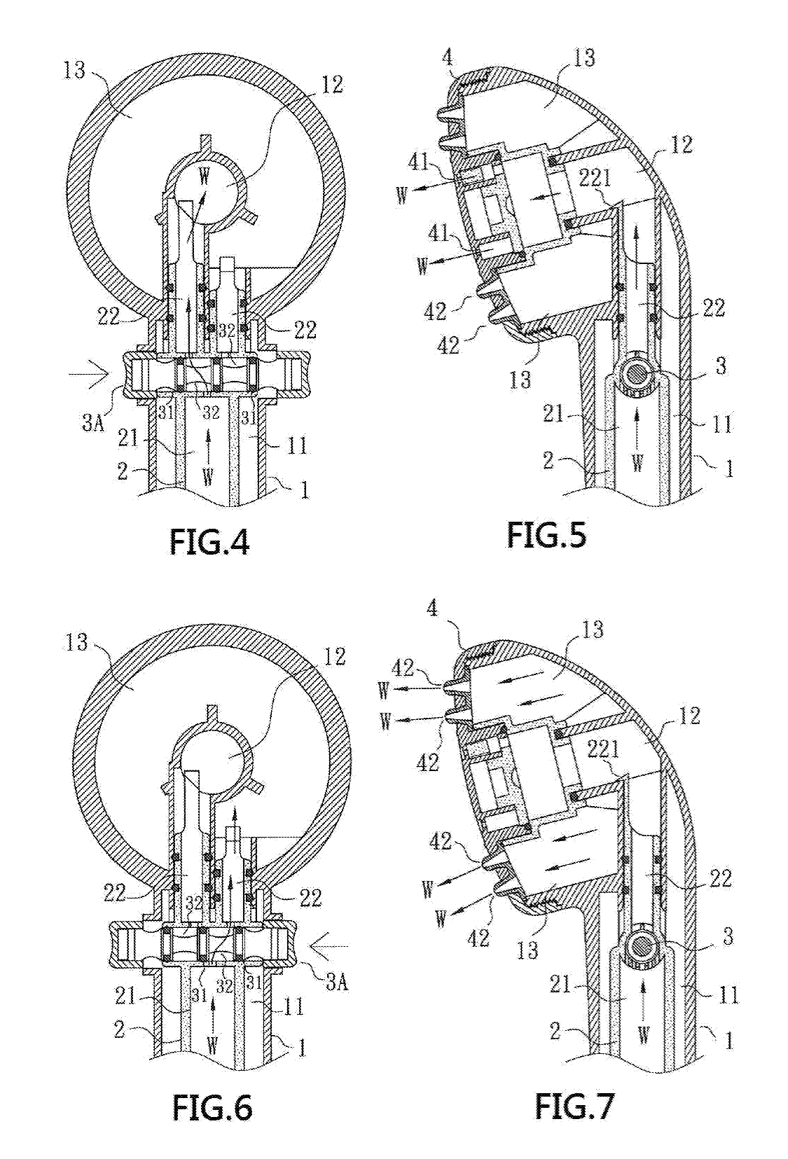

As shown in FIGS. 4 and 5, in one operation, a user may press the left press button 3A to unblock the first port A. Thus, water (W) may flow from the inlet 21 to the central nozzles 41 via the first port A, the second port B and one outlet 22.

As shown in FIGS. 6 and 7, in the other operation, a user may press the right press button 3A to unblock the first port A. Thus, water (W) may flow from the inlet 21 to the peripheral nozzles 42 via the first port A, the third port C and the other outlet 22.

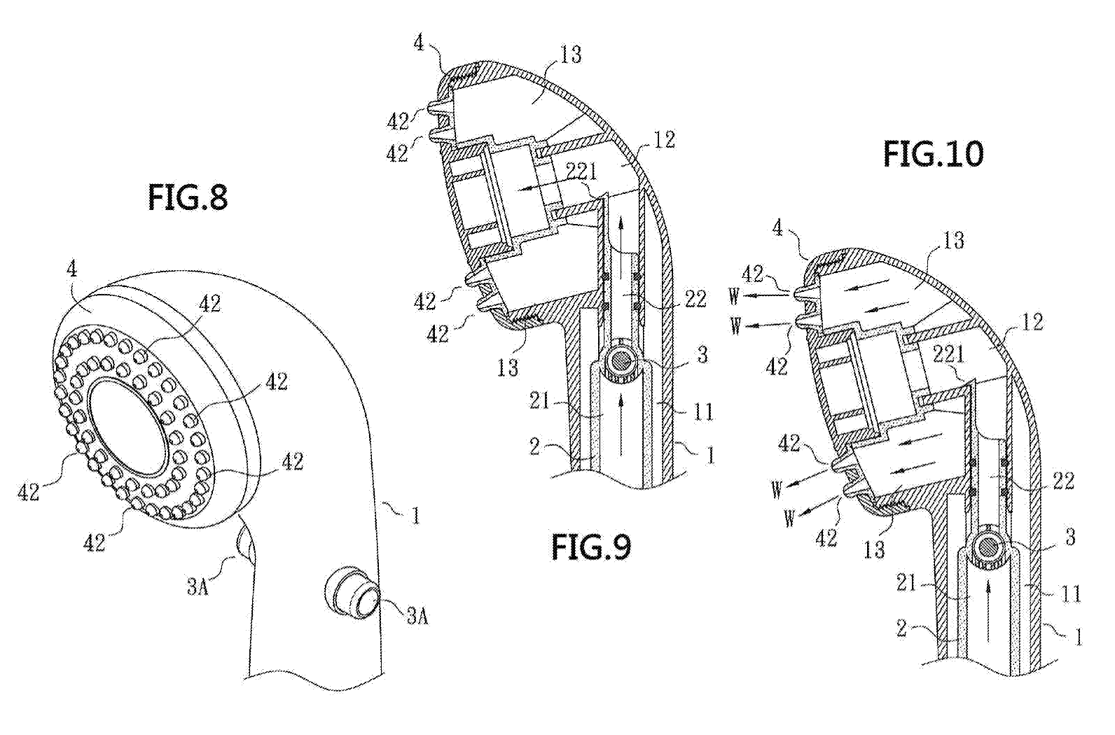

Referring to FIGS. 8 to 10, a shower head in accordance with a second preferred embodiment of the invention is shown. The characteristics of the second preferred embodiment are substantially the same as that of the first preferred embodiment except the following: The central nozzles are eliminated. Water can flow out of the peripheral nozzles 42 by pressing the right press button 3A.

While the invention has been described in terms of preferred embodiments, those skilled in the art will recognize that the invention can be practiced with modifications within the spirit and scope of the appended claims.

What is claimed is:

1. A shower head comprising:
a spray handle;
a conduit disposed in the spray handle and including an inlet having a first port, a first outlet having a second port, and a second outlet having a third port;
a nozzle assembly releasably secured to the spray handle and including a plurality of central nozzles and a plurality of peripheral nozzles;
a central channel disposed in the spray handle and communicating with both the first outlet and the central nozzles;
a peripheral channel disposed around the central channel and communicating with both the second outlet and the peripheral nozzles;
a sliding valve disposed between the inlet and the first and second outlets, the sliding valve including three spaced disc members and two annular cavities each between two adjacent disc members; and
two opposite push buttons secured to two ends of the sliding valve respectively;
wherein in an inoperative position the first port neither communicates with the second port nor communicates with the third port;
wherein a pressing of one press button unblocks the first port to flow water from the inlet to the central nozzles via the first port, the second port, and the first outlet; and
wherein a pressing of the other press button unblocks the first port to flow water from the inlet to the peripheral nozzles via the first port, the third port, and the second outlet.
